(19) United States
(12) Patent Application Publication
(10) Pub. No.: US 2014/0113479 A1
(43) Pub. Date: Apr. 24, 2014

(54) CONNECTOR OF ELECTRIC VEHICLE CHARGER

(71) Applicant: LS CABLE & SYSTEM LTD., Anyang-si (KR)

(72) Inventor: Doo Han YOON, Anyang-si (KR)

(73) Assignee: LS Cable & System Ltd., Anyang-si (KR)

(21) Appl. No.: 13/657,024

(22) Filed: Oct. 22, 2012

(51) Int. Cl. H01R 13/62

(52) U.S. Cl. 439/372

(57) ABSTRACT

There is disclosed a connector of an electric vehicle charger, more particularly, to a connector of an electric vehicle charger which can be assembled and dissembled easily, with an easy maintenance, a simple structure and a less number of parts.

### BACKGROUND OF THE DISCLOSURE

1. Field of the Disclosure

The present invention relates to a connector of an electric vehicle charger, more particularly, to a connector of an electric vehicle charger which can be assembled and dissembled easily, with an easy maintenance, a simple structure and a less number of parts.

2. Discussion of the Related Art

Recently, there have been increasing interests on an electric vehicle because of the recently rising oil price or environmental problems. Such an electric vehicle includes a driving motor and a higher-capacity battery to supply an electric power required to operate various electric devices. To distribute electric vehicles, an electric vehicle charger which charges the electric vehicle is required.

Such an electric vehicle charger may include a charging station for electric power supply and control and a connector detachably mounted to an inlet of an electric vehicle to supply the electric energy provided by the charging station to the inlet provided in the electric vehicle.

A conventional connector for an electric vehicle according to the prior art includes a plurality of terminals connected with a plurality of cables, a rear holder configured to prevent the terminals from moving backwards, a waterproof material disposed in front of the rear holder to make the terminals be waterproof, a terminal position assurance locking (TPA) disposed in front of the rear holder and the waterproof material to assure positions of the terminals.

In the conventional connector for the electric vehicle according to the prior art, the plurality of the cables may be inserted in the rear holder, the waterproof material and the terminal position assurance locking. After that, ends of the cables are stripped and pressed at ends of the terminals and an assembling process is completed then. If an error occurs in one of the cables, all of the cables have to be cut off from the ends of the terminals and they have to be separated from the rear holder, the waterproof material and the terminal position assurance locking in the conventional connector assembled in the sequential process mentioned above inconveniently. In addition, if an error occurs in some of components composing the connector, rather than the cable error, it is not easy to replace some components having an error in the connector for the electric vehicle according to the prior art.

Moreover, in the conventional connector, the terminal position assurance locking for assuring the positions of the terminals is independent from the rear holder and the number of parts happens to increase inevitably. Accordingly, the production cost might be getting high and assembling works might increase.

### SUMMARY OF THE DISCLOSURE

An object of the present invention is to provide a connector of an electric vehicle charger which is able to reduce the number of parts, with a simple structure.

Another object of the present invention is to provide a connector of an electric vehicle charger which can be easily assembled and dissembled.

A further object of the present invention is to provide a connector of an electric vehicle charger which can definitely assure accommodation positions or mounting positions of terminals provided therein.

A still further object of the present invention is to provide a connector of an electric vehicle charger which can make an internal space thereof waterproof.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings. To achieve these objects and other advantages and in accordance with the purpose of the invention, as embodied and broadly described herein, a connector of an electric vehicle charger includes a case; a terminal housing mounted in the case; a rear holder detachably mounted in the terminal housing; and a plurality of terminals inserted in the terminal housing via the rear holder, with hooking protrusions formed in outer circumferential surfaces thereof, respectively.

A hooking protrusion of each terminal may be positioned between the terminal housing and the rear holder, and a first terminal fixing part may be provided in the terminal housing to prevent the hooking protrusion of each terminal from moving forwards, and a second terminal fixing part may be provided in the rear holder to prevent the hooking protrusion of each terminal from moving backwards.

The first terminal fixing part may include a plurality of rear guide members extended from the terminal housing backwards, and the second terminal fixing part comprises a plurality of clip members extended from the rear holder forwards to face the plurality of the rear guide members, when the terminal housing and the rear holder are coupled to each other.

The clip member may include an elastic transformable part comprising: an inclined surface configured to guide the sliding movement of the hooking protrusion when the terminals pass the clip members; and a hooking surface to support a rear surface of the hooking protrusion.

The rear guide member may be extended from the terminal housing to be spaced apart a predetermined distance from the clip member as far as the thickness of the hooking protrusion, when the terminal housing and the rear holder are coupled to each other.

An outer diameter of the rear guide member may be identical to the height of the hooking protrusion.

The rear holder may include a plurality of position assurance members provided between the clip members, to insert the rear guide members there through, and an inner diameter of the position assurance member is identical to the height of the hooking protrusion.

The rear holder may include a plurality of rear accommodating members extended from the rear holder backwards, in communication with the clip members, and a sealing member is provided in the rear accommodating member, with a through hole where the cables pass.

The sealing member may include an elastic part positioned in the rear accommodating member forwards; and a rigid part coupled to a rear surface of the elastic part.

The elastic part may have a bellow shape and an outer diameter of the elastic part may be larger than an inner diameter of the rear accommodating member.

The elastic part may be formed of rubber and the rigid part is formed of plastic.

The sealing member may include a plurality of rigid seams formed of a rigid material to pass through the elastic part and the rigid part.

The terminal housing and the rear holder may be detachably mounted in the case.

A ring type rib may be projected inwards in the case to close airtight a predetermined area of a rear accommodating member provided in the rear holder.

An inner diameter of the ring type rib may be smaller than a diameter of a common circumscribed circle surrounding the plurality of the rear accommodating members.

At least one ring type hooking protrusion may be provided in an outer circumferential surface of the terminal housing, and at least one ring type projection may be projected from the case inwards to support the ring type hooking protrusion of the terminal housing.

The plurality of the terminals may include at least one communication terminal and at least one electric terminal.

In another aspect of the present invention, a connector of an electric vehicle charger includes a case; a rear holder detachably mounted in the terminal housing; a plurality of terminals comprising a hooking protrusion formed in an outer circumferential surface thereof, with cables connected thereto; and a sealing member coupled to the rear holder to pass the cables there through.

A hooking protrusion of each terminal may be positioned between the terminal housing and the rear holder when the terminals are inserted in the terminal housing via the rear holder. A rear guide member may be provided in the terminal housing to contact with a front surface of the hooking protrusion of each terminal and a plurality of clip members provided in the rear holder to contact with a rear surface of the hooking protrusion of each terminal.

The rear guide member may prevent forward moving of the terminals and the clip member may prevent backward moving of the terminals.

The clip member may include an elastic transformable part comprising: an inclined surface configured to guide the sliding movement of the hooking protrusion when the terminals pass the clip members; and a hooking surface to support a rear surface of the hooking protrusion.

The rear guide member may be extended from the terminal housing to be spaced apart a predetermined distance from the clip member as far as the thickness of the hooking protrusion, when the terminal housing and the rear holder are coupled to each other.

The connector of the electric vehicle according to the present invention may have following effects. According to the present invention, the structure of the connector can be simplified and the number of the parts composing the connector can be reduced according to the present invention. Accordingly, the present invention may enhance the productivity of the connector and lower the production cost simultaneously.

Furthermore, the connector according to the present invention can be easily assembled and dissembled. The components provided in the connector according to the present invention can be easily assembled and dissembled. Specifically, after pressed and connected to the cables, the terminals can be separately inserted in the rear holder and the terminal housing. Accordingly, the pressing and connecting process between the cables and terminals can be performed easily and the assembling or dissembling process of the terminal housing and the rear holder can be performed easily. The assembling and dissembling process between the assembly of the terminal housing and the rear holder and the terminals may be performed easily. Accordingly, when each of the components is damaged (for example, a pressure state error generated between the connected parts of the terminals and the cables) or the components need replacing, the assembling and dissembling between the components is performed easily and maintenance of the connector can be performed efficiently.

Still further, the accommodating or coupling positions of the terminals can be assured within the connector definitely. Specifically, the ring type hooking protrusion is fixed between the terminal housing and the rear holder, only to assure the accommodating or coupling positions of the terminals.

Still further, the coupling positions of the terminal housing and the rear holder mounted in the connector according to the present invention definitely. Especially, the forward and backward moving of the terminal housing and the rear holder within the case can be prevented.

Still further, the sealing member is positioned in the front or rear portion of the rear holder. The separation of the sealing member can be prevented and the inside of the connector can be made waterproof accordingly.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

In the drawings:

FIG. 1 is an exploded perspective view schematically illustrating a connector of an electric vehicle according to the present invention;

FIG. 2 is a perspective view schematically illustrating an inside of the connector of the electric vehicle charger;

FIG. 3 is a side view illustrating the inside of the connector of the electric vehicle charger;

FIG. 4 is a rear perspective view schematically illustrating a terminal according to the present invention;

FIG. 5 is an inner perspective view of a case according to the present invention;

FIG. 6 is a rear perspective view of a terminal housing according to the present invention;

FIG. 7 is a plane view of the terminal housing according to the present invention;

FIG. 8 is a side view of the terminal housing according to the present invention;

FIG. 9 is a side view of a rear holder according to the present invention;

FIG. 10 is a rear perspective view of the rear holder according to the present invention;

FIG. 11 is a rear view of the rear holder according to the present invention;

FIG. 12 is a front perspective view of the rear holder according to the present invention;

FIG. 13 is a front view of the rear holder according to the present invention;

FIG. 14 is a longitudinal sectional view of the rear holder along A-A of FIG. 13;

FIG. 15 is a longitudinal sectional view of the rear holder along B-B of FIG. 13;

FIG. 16 is a front perspective view of a sealing material according to the present invention;

FIG. 17 is a side view of the sealing material according to the present invention; and

FIG. 18 is a front view of the sealing material according to the present invention.

### DESCRIPTION OF SPECIFIC EMBODIMENTS

In an aspect of the present invention, a connector of an electric vehicle charger according to one embodiment of the present invention may include a case, a terminal housing mounted in the case, a rear holder detachably mounted to the terminal housing, and a plurality of terminals inserted in the terminal housing via the rear holder, with hooking protrusions formed in outer circumferential surfaces thereof, respectively.

In this instance, the hooking protrusion formed in each of the terminals is positioned between the terminal housing and the rear holder. A first fixing part is provided in the terminal housing to prevent the hooking protrusion of each terminal from moving forward and a second terminal fixing part is provided in the rear holder to prevent the hooking protrusion from moving backwards.

In addition, the first terminal fixing part may include a plurality of rear guide members extended from the terminal housing backwards. The second terminal fixing part may include a plurality of clip members extended from the rear holder forward to face the rear guide members when the terminal housing is coupled to the rear holder.

In another aspect of the present invention, a connector of an electric vehicle charger according to one embodiment of the present invention includes a case, a terminal housing mounted in the case, a rear holder detachably coupled to the terminal housing, a plurality of terminals connected with cables, with hooking protrusions formed in outer circumferential surfaces thereof, respectively, and a sealing member coupled to the rear holder to make the cable pass there through.

When the terminal is inserted in the terminal hosing via the rear holder, the hooking protrusions formed in the terminals, respectively, may be positioned between the terminal housing and the rear holder.

A rear guide member is provided in the terminal housing to contact with a front surface of each hooking protrusion formed in each terminal and a plurality of clip members is provided in the rear holder to face with a rear face of the hooking protrusion.

In addition, the rear guide member may prevent the forward moving of the terminal and the clip members may prevent the rear moving of the terminal.

One hooking protrusion or a plurality of hooking protrusions may be provided. The hooking protrusion may have a ring shape. When it has such a ring shape, the hooking protrusion may be referenced to as a ring type hooking protrusion. The hooking protrusion may be extended a predetermined height from the outer circumferential surface of the terminal. In case that the hooking protrusion is the ring type, the height of the protrusion may be an outer diameter of the ring type hooking protrusion.

Exemplary embodiments of the present invention will be described in detail as follows, referring to the accompanying drawings. The present invention may not be limited to the embodiments which will be described as follows and may be specified in other types. Embodiments described herewith are provided to deliver a subject matter of the present invention to people skilled in the art to which the present invention pertains sufficiently. Reference will now be made in detail to the specific embodiments of the present invention, examples of which are illustrated in the accompanying drawings. Wherever possible, the same reference numbers will be used throughout the drawings to refer to the same or like parts.

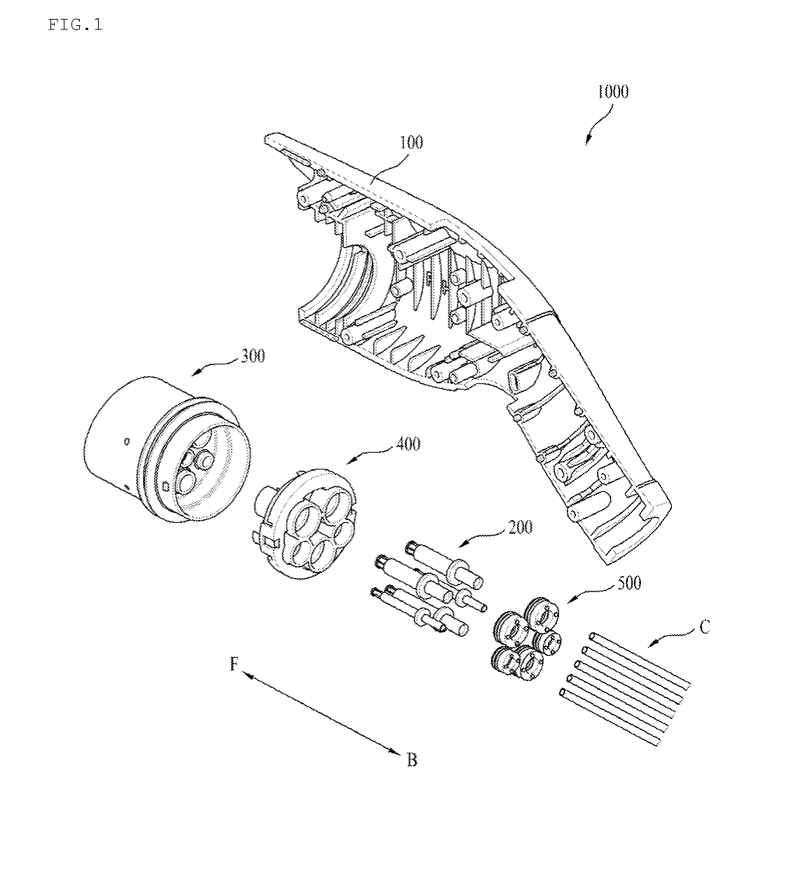

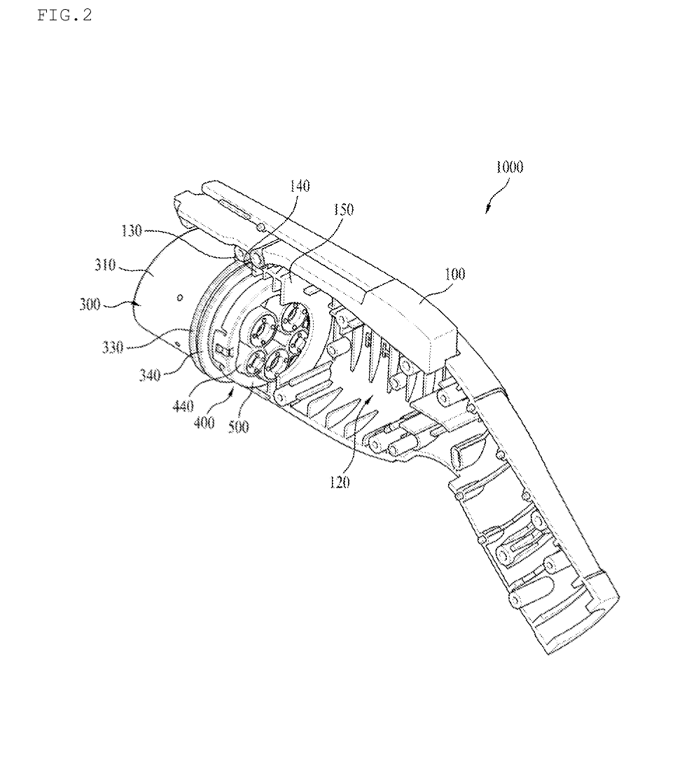

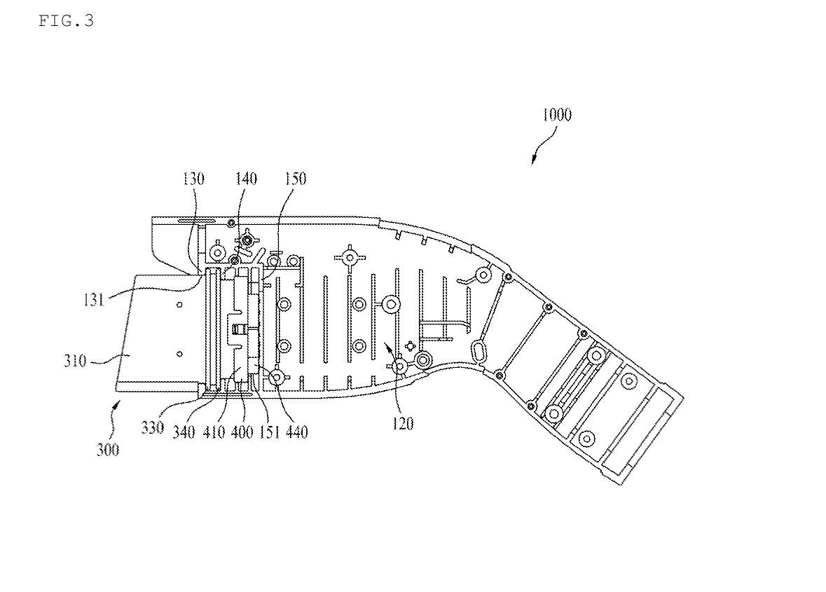

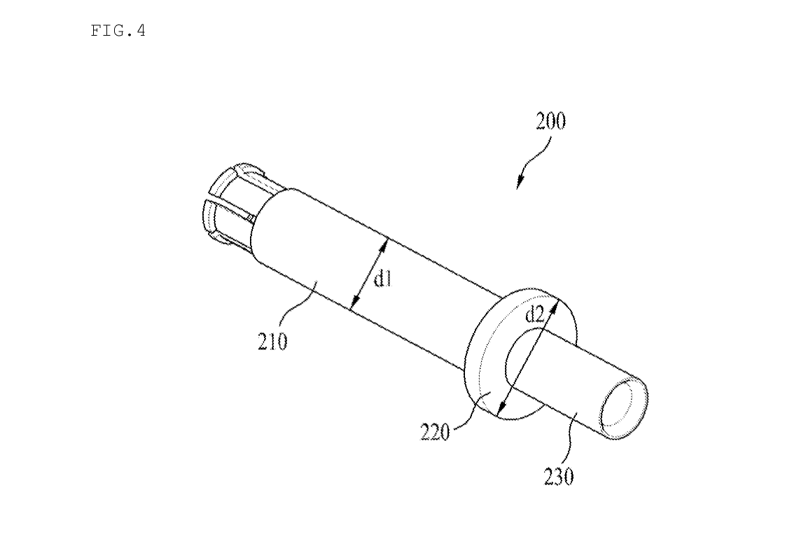

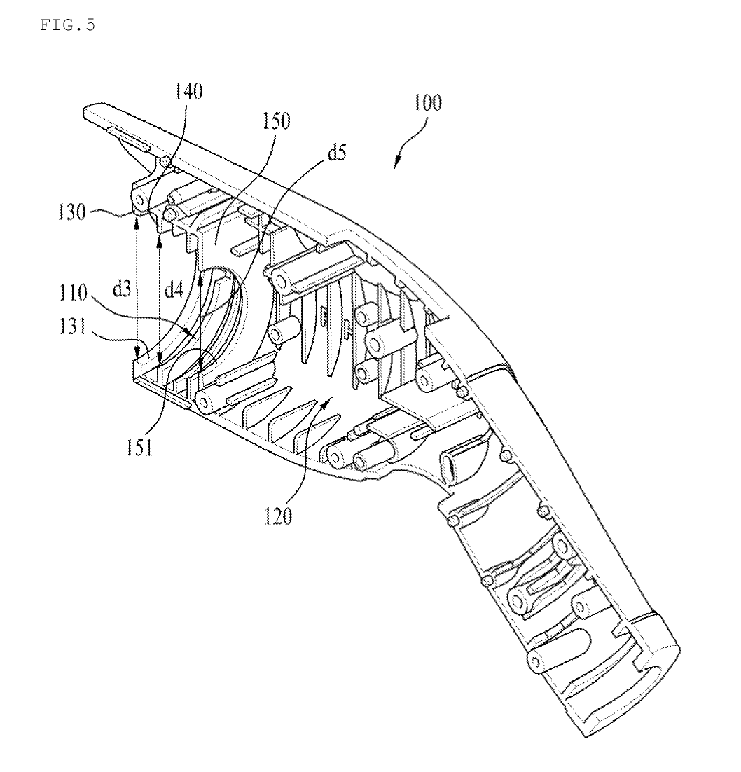

FIG. 1 is an exploded perspective view schematically illustrating a connector 1000 of an electric vehicle according to the present invention. FIG. 2 is a perspective view schematically illustrating an inside of the connector 1000 of the electric vehicle charger. FIG. 3 is a side view illustrating the inside of the connector 1000 of the electric vehicle charger. FIG. 4 is a rear perspective view schematically illustrating a terminal 200 according to the present invention. FIG. 5 is an inner perspective view of a case 100 according to the present invention. The direction toward an inlet of an electric vehicle may be forward or toward a front surface. The reverse direction with respect to the inlet of the electric vehicle may be backwards or toward a rear surface.

As shown in FIGS. 1 to 3, the connector 1000 of the electric vehicle charger according to the present invention includes a plurality of terminals 200 connected with a communication cable and/or an electric cable to electrically link to a terminal provided in an inlet of the electric vehicle to charge the electricity for the electric vehicle, a terminal housing 300 configured to accommodate the terminals 200, a rear holder 400 configured to support and fix the terminals 200 accommodated by the terminal housing 300, and a case 100 configured to detachably accommodate the terminal housing 300 and the rear holder 400.

As shown in FIGS. 2 and 3, the terminal housing 300 and the rear holder 400 may be detachably assembled to each other. The assembly of the terminal housing 300 and the rear holder 400 is fixedly received in an inner front portion of the case 100. Preferably, the assembly of the terminal housing 300 and the rear holder 400 may be insertedly fitted to the shape of the case 100.

A plurality of sealing members 500 may be received in a rear end of the rear holder 400 to make waterproof an inside of the assembly of the terminal housing 300 and the rear holder 400. The plurality of the sealing members 500 may be forcedly fitted to the rear end of the rear holder 400.

As shown in FIG. 4, the terminal 200 may be a male terminal 200 electrically connected to a female terminal (not shown) provided in the inlet of the electric vehicle. At least one of the terminals 200 may be a communication terminal 200 and at least one of the terminals 200 may be an electric terminal 200. Five terminals 200 are provided in the present specification. That is one of the examples and the present invention is not limited thereto.

The number of rear and front accommodating members 440 and 430 provided in the rear holder 400 and the number of rear and front guide members 323 and 311 provided in the terminal housing 300, which will be described later, may be corresponding to the number of the terminals 200.

Each of the terminals 200 is received and fixed in each rear accommodating member 440 and each front accommodating member 430 of the terminal housing 300 and each rear guide member 323 and each front guide member 311 of the terminal housing 300.

Specifically, the terminals 200 may be inserted in the assembly of the terminal housing 300 and the rear holder 400 via the rear accommodating members 400 of the rear holder 400 separately, to be detachably fixed in the rear holder 400 of the terminal housing 300, respectively. For that, the assembly of the terminal housing 300 and the rear holder 400 may include a plurality of terminal fixing parts. Each of the terminal fixing parts may include a plurality of clip members 433 partially formed of the front accommodating member 440 of the rear holder, which will be described later, a plurality of rear guide members 323 of the terminal housing, which will be described later. More specifically, the terminal fixing part includes the plurality of the clip members 433 extended from the rear holder forward and a plurality of a rear guide members 323 extended from the terminal housing backwards to face the clip members 433 when the terminal housing and the rear holder are coupled to each other. The clip members 433 and the rear guide members 323 provided in the terminal fixing part will be described in detail later.

As shown in FIG. 4, each of the terminals 200 may include a connection part 210 electrically connected to a plurality of female terminals provided in the inlet of the electric vehicle, a ring type hooking protrusion 220 formed in an outer circumferential surface of an end of the connection part 210, and a connected part 230 extended from the ring type hooking protrusion 220 backwards to have the cable pressed and connected thereto.

The connection part 210 is cylindrical-shaped and it is assembled in the rear guide member 323 and the front guide member 311 of the terminal housing 300, which will be described later, when the terminals 200 are assembled in the assembly of the terminal housing 300 and the rear holder 400. At this time, an outer diameter (d1) of the connection part 210 is identical to an inner diameter of the rear guide member provided in the terminal housing 300, which will be described later, and an inner diameter of the front guide member 311. Accordingly, coupling positions and accommodating positions of the terminals 200 and the connection part 210 of the terminal 200 can be assured in the terminal housing 300.

The ring type hooking protrusion 220 may be formed in an end of the connection part 210 and an outer diameter (d2) of the ring type hooking protrusion 200 is larger than an outer diameter of the connection part 210. The ring type hooking protrusion 220 may be fixed in the assembly of the terminal housing 300 and the rear holder 400 by a terminal fixing part. In other words, the ring type hooking protrusion 220 may be fixedly positioned between the terminal housing 300 and the rear holder 400 within the assembly of the terminal housing 300 and the rear holder 400. Specifically, a front surface of the ring type protrusion 220 is supported by a free end of the rear guide member 323 provided in the terminal housing 300. A rear surface of the ring type hooking protrusion 220 is supported by a free end of the clip member 433 provided in the front accommodating member 430 of the rear holder, which will be described later. At this time, it is preferred that the rear guide member and the clip member are formed in the terminal housing and the rear holder, respectively, to make the free ends thereof be spaced apart as a predetermined distance as the thickness of the ring type hooking protrusion when the terminal housing and the rear holder are coupled to each other.

The connected part 230 is a portion where the end of the striped cable is electrically connected after pressed. Before pressing the end of the cable to the connected part 230, the sealing member 500 which will be described later is provided in a circumference of the connected part 230 or a circumference of the cable end. According to the present invention, the striped end of the cable is pressed and connected to the connected part of the terminal and each of the terminals is inserted in the assembly of the terminal housing and the rear holder after that, only to make the pressing connection process between the terminals and the cable performed easily.

As shown in FIGS. 2, 3 and 5, the case 100 may include a left portion and a right portion. The left portion and the right portion may be separably assembled. However, that is one of examples and the present invention is not limited thereto. The case may consist of parts that are able to be assembled.

The case 100 may include a first accommodating room 110 that detachably accommodates the assembly of the terminal housing 300 and the rear holder 400, with a front opening and a rear opening, and a second accommodating room 120 formed behind the rear opening to accommodate the cables connected to the terminals 200.

The first accommodating room 110 of the case 100 is defined by a first ring type projection 130 projected toward the inside of the case 100 to limit the front opening and a ring type rib 150 projected to the inside of the case 100 to limit the rear opening, spaced apart a predetermined distance from the first ring type projection 130. Such a predetermined distance may be a distance from the first ring type hooking protrusion 330 of the terminal housing 300, which will be described later, to the free end of the rear accommodating member 440 of the rear holder 400, which will be described later.

A second ring type projection 140 projected toward the inside of the case 100 is formed spaced apart a predetermined distance from the first ring type projection 130 within the first accommodating room 110.

It is preferred that an inner diameter (d3) of the first ring type projection 130 is identical to an outer diameter (d8) of a front cylindrical part 310 provided in the terminal housing 300 which will be described later and that an inner diameter (d4) of the second ring type projection 140 is identical to an outer diameter (d9) of a rear cylindrical part 320 of the terminal housing 300 which will be described later. The first ring type projection 130 and the second ring type projection 140 may prevent the terminal housing 300 from moving forwards and backwards within the first accommodating room 110, to assure the accommodating or coupling position of the terminal housing 300 within the case 100.

The ring type rib 150 may be projected toward the inside of the case 100 to limit the rear opening where the cables connected to the terminals 200 pass. At this time, the ring type rib 150 may be projected inwardly to close a predetermined area of the rear accommodating member of the rear holder airtight, when the assembly of the terminal housing and the rear holder is mounted in the case. Specifically, an inner diameter (d5) of the rear opening 151 (or an inner diameter (d5) of the ring type rib 150) may be smaller than a diameter (d10) of a common circumscribed circle surrounding the rear accommodating members 440 provided in the rear holder 400 which will be described later. However, to pass the cables there through, an inner diameter (d5) of the rear opening 151 (or an inner diameter (d5) of the ring type rib 150) has to be larger than a diameter of a common circumscribed circle surrounding a through hole (501) (for the cable) of the sealing member 500 accommodated by the plurality of the rear accommodating members 440 which will be described later.

The ring type rib 150 has such the inner diameter as mentioned above, to definitely prevent the rear holder 400 from moving backwards within the first accommodating room 110 of the case 100 and simultaneously to prevent the sealing member 500 accommodated by the rear accommodating member 440 of the rear holder 400 from moving backwards. Accordingly, the accommodating or coupling position of the rear holder 400 within the case 100 may be assured and the inside of the assembly of the terminal housing 300 and the rear holder 400 may be made waterproof definitely.

As such the inner structure of the case 100 is provided as mentioned above, the assembling position of the assembly of the terminal housing 300 and the rear holder 400 may be assured easily when the assembly is assembled to the case 100. Accordingly, the assembling speed of the connector can be enhanced and the coupling or accommodating positions of the terminal housing 300 and the rear holder 400 within the case 100 can be assured simultaneously, to assure the coupling or accommodating positions of the terminals within the case 100.

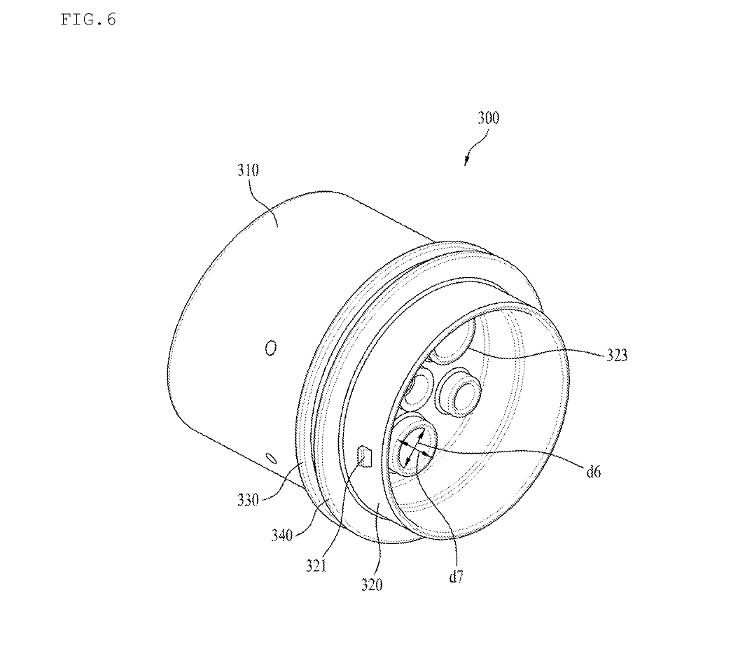

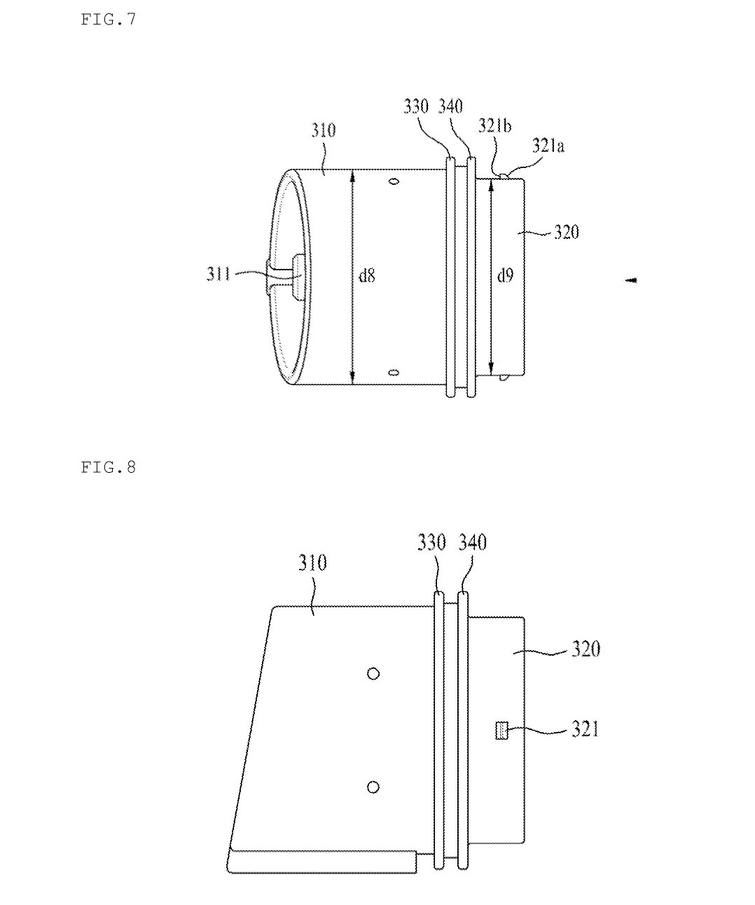

FIG. 6 is a rear perspective view of the terminal housing 300 according to the present invention. FIG. 7 is a plane view of the terminal housing 300 according to the present invention. FIG. 8 is a side view of the terminal housing 300 according to the present invention.

As shown in FIGS. 6 to 8, the terminal housing 300 includes a front cylindrical part 310 mechanically coupled to the inlet of the electric vehicle, with lying forwards, and a rear cylindrical part 320 having the rear holder 400 detachably coupled thereto, with lying backwards.

An outer diameter (d8) of the front cylindrical part 310 is identical to an inner diameter (d3) of the first ring type projection 130 provided in the case 100 or a diameter of the front opening 131 provided in the case 100. The front cylindrical part 310 may include a plurality of front guide members 311 provided therein forwards. The front guide members 311 are cylindrical-shaped and an inner diameter of a front guide member 311 is identical to an outer diameter (d1) of the connection part 210 provided in the terminal 200. In other words, the front guide members 311 may accommodate the terminals 200 (or the connection parts 210 of the terminals 200) to assure the coupling or accommodating positions of the terminals 200.

An outer diameter (d9) of the rear cylindrical part 320 is identical to an inner diameter (d4) of the second ring type projection 140 provided in the case 100. Also, an outer diameter (d9) of the rear cylindrical part 320 is identical to an inner diameter (d13) of a rear cover 410 provided in the rear holder 400 which will be described later. In other words, a fixing end of the rear cylindrical part 320 is surrounded by the second ring type projection 140 of the case 100, when the terminal housing 300 is positioned in the case 100. A free end of the rear cylindrical part 320 is inserted in a rear cover 410 of the rear holder 400 which will be described later, when the terminal housing 300 and the rear holder 400 are assembled.

The rear cylindrical part 320 may include a plurality of rear guide members 323 lying backwards therein. The rear guide members 323 support the front surfaces of the ring type hooking projections 220 provided in the terminals 200, when the terminal housing 300 and the rear holder 400 are coupled to each other, to prevent the terminals 200 from moving forwards within the assembly of the terminal housing 300 and the rear holder 400.

Specifically, the rear guide members 323 support the front and rear surfaces of the ring type hooking protrusions 220 of the terminals 200, together with the clip members 433 of the rear holder 400 which will be described later, to prevent the terminals 200 from moving within the assembly of the terminal housing 300 and the rear holder 400. Accordingly, the accommodating or coupling positions of the terminals 200 can be assured within the case or within the assembly of the terminal housing 300 and the rear holder 400.

An outer diameter (d6) of the rear guide member 323 is identical to an inner diameter (d12) of a position assurance locking 431 provided in the rear holder 400 which will be described later. An inner diameter (d7) of the rear guide member 323 is identical to an outer diameter (d1) of the connection part 210 provided in the terminal 200. In other words, when the terminal housing 300 and the rear holder 400 are coupled to each other, the rear guide members 323 accommodate the connection parts 210 of the terminals 200 and the rear guide members 323 are inserted in the position assurance locking 431 of the rear holder 400 which will be described later.

The height of the rear guide member 323 is the distance between the free end of the clip member 433 of the rear holder 400 and the free end of the rear guide member 323 which are spaced apart as far as the thickness (t) of the ring type hooking protrusion 330, when the terminal housing 300 and the rear holder 400 are coupled to each other. In other words, the distance between the free ends of the rear guide member 323 and the clip member 433 of the rear holder 400 within the assembly of the terminal housing 300 and the rear holder 400 with no terminals 200 inserted therein may be identical to the thickness of the terminal 200. Accordingly, when the terminals 200 are inserted after the terminal housing 300 and the rear holder 400 are coupled to each other, the ring type hooking protrusions 220 of the terminals 200 may be firmly supported by the free ends of the rear guide members 323 of the terminal housing 300 and the free ends of the clip members 433 of the rear holder 400 which will be described later.

As shown in FIGS. 7 and 8, two coupling projections 321 are provided in an outer circumferential surface of the rear cylindrical part 320. Each of the coupling projections 321 includes an inclined surface 321a inclined backwards to make a leg 411 of the rear holder slide there along and a hooking surface 321b engaging with a coupling recess 413 formed in the leg 411 of the rear holder 400, when the terminal housing 300 and the rear holder 400 are coupled to each other.

The coupling projections 321 of the terminal housing 300 and the leg 411 of the rear holder 400 may enable the rear holder 400 to slide with respect to the terminal housing 300, to assemble the rear holder 400 to the terminal housing 300 easily. Moreover, the leg 411 has an elastic structure which will be described later and the leg 311 is broadened to detach itself from the coupling projections 321 easily. Accordingly, the rear holder 400 may be dissembled from the terminal housing 300 efficiently.

According to the present invention, two coupling projections 321 are provided and that is one of examples. The present invention is not limited to two coupling projections 321.

As shown in FIGS. 6 to 8, the terminal housing 300 includes a first ring type hooking protrusion 330 projected from an outer circumferential surface of a fixed end of the front cylindrical part 310 outwards and a second ring type hooking protrusion 340 projected outwards, spaced apart a predetermined distance from the first ring type hooking protrusion 330.

The first ring type hooking protrusion 330 is supported by the first ring type projection 130 provided in the case 100 and the second ring type hooking protrusion 340 is supported by the second ring type projection 140 provided in the case 100. Specifically, a front surface of the second ring type hooking protrusion 340 is supported by the second ring type projection 140, to prevent the backward moving of the second ring type hooking protrusion 340. In other words, the first ring type hooking protrusion 330 and the second ring type hooking protrusion 340 of the terminal housing 300 may be insertedly positioned between the first ring type projection 130 and the second ring type projection 140 provided in the case 100.

It is preferred that an outer diameter (d8) of the front cylindrical part 310 is identical to an inner diameter (d3) of the first ring type projection 130 and that an outer diameter (d9) of the rear cylindrical part 320 is identical to an inner diameter (d4) of the second ring type projection 140 provided in the case 100.

The rear cylindrical part 320 is lying from the second ring type hooking protrusion 340 backwards.

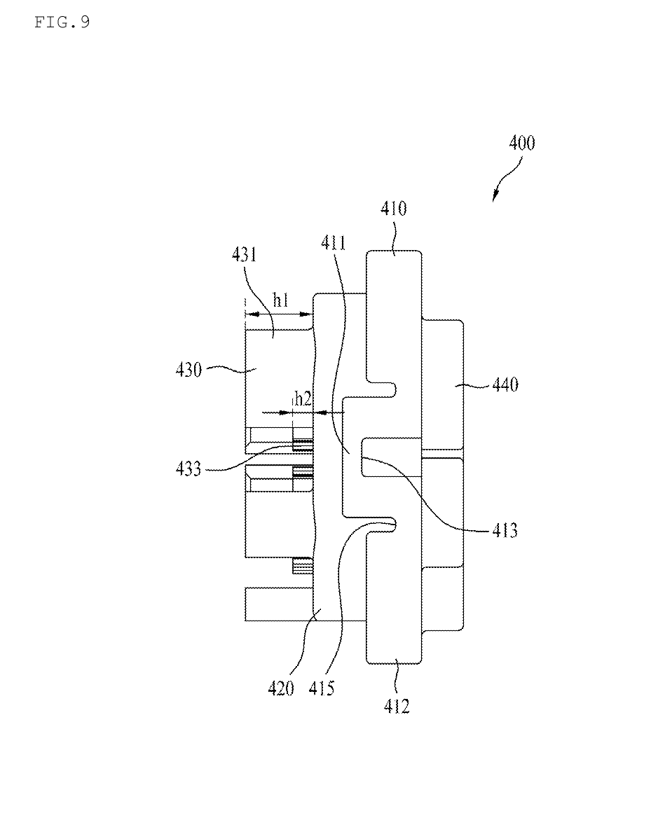

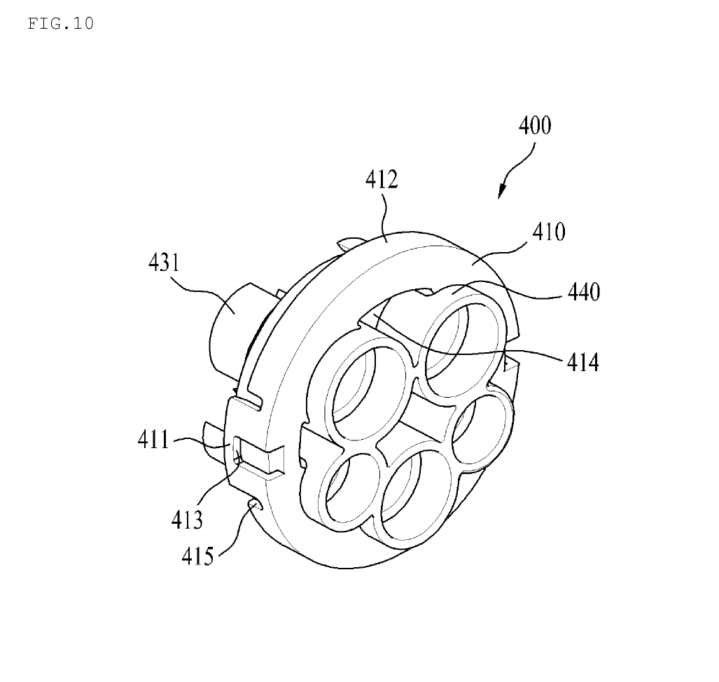

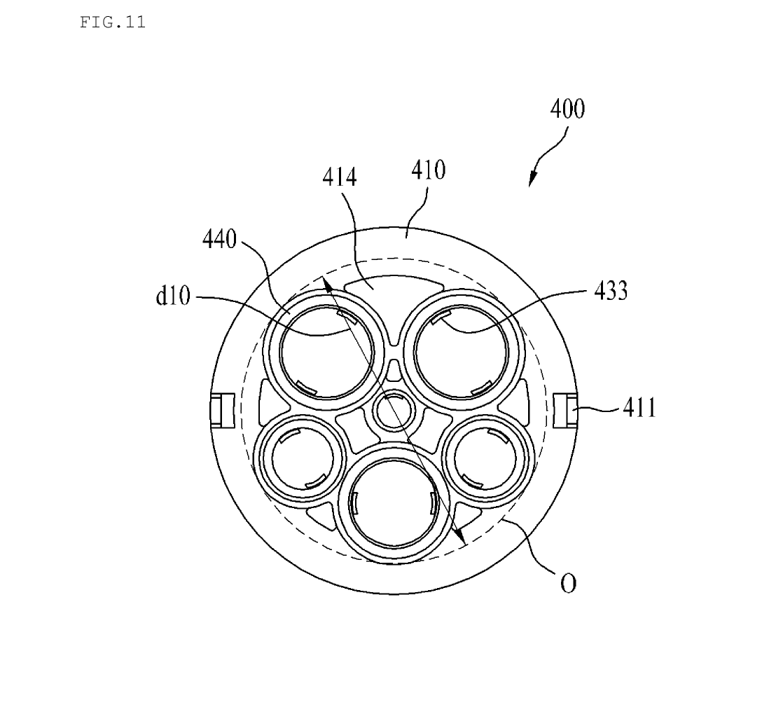

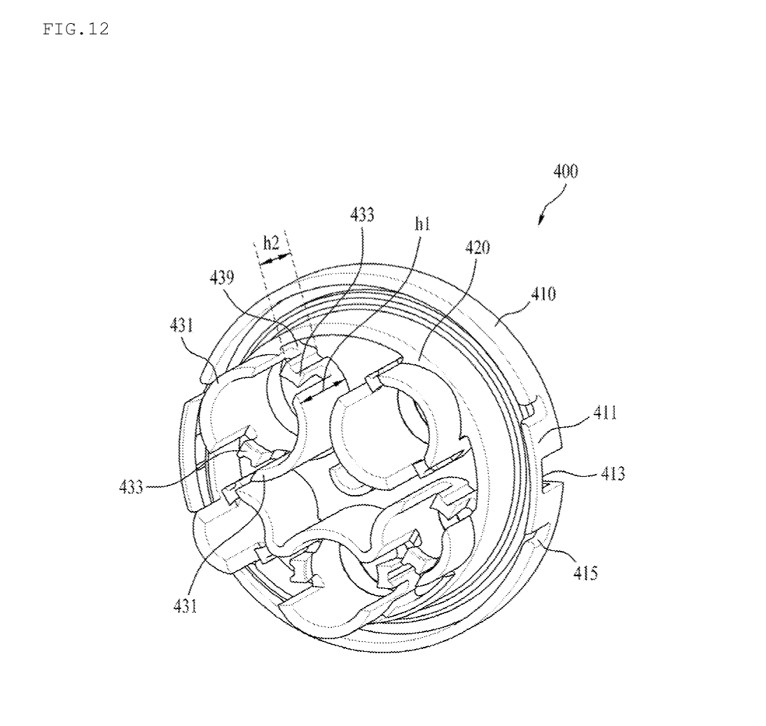

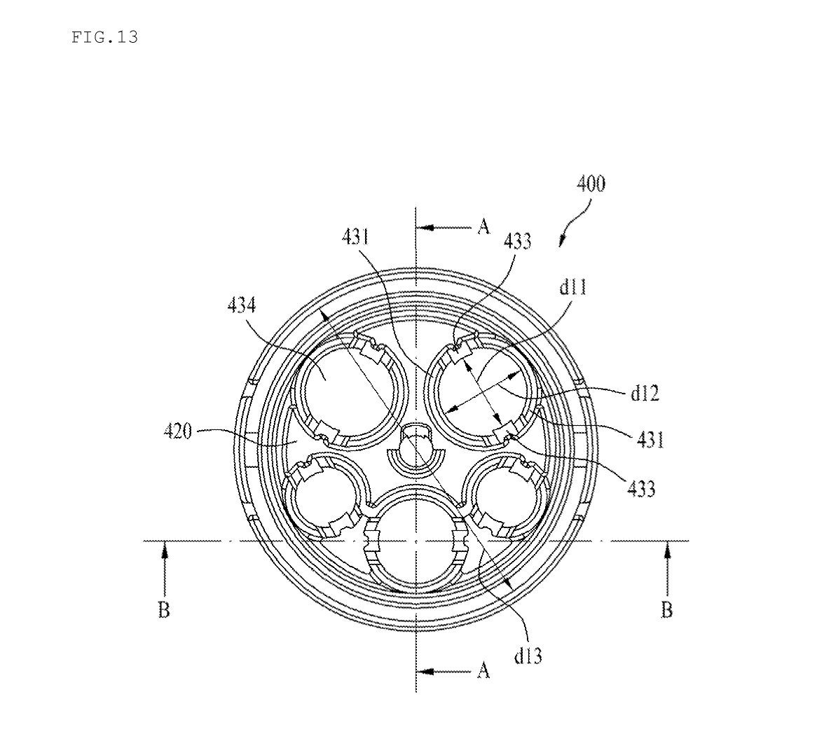

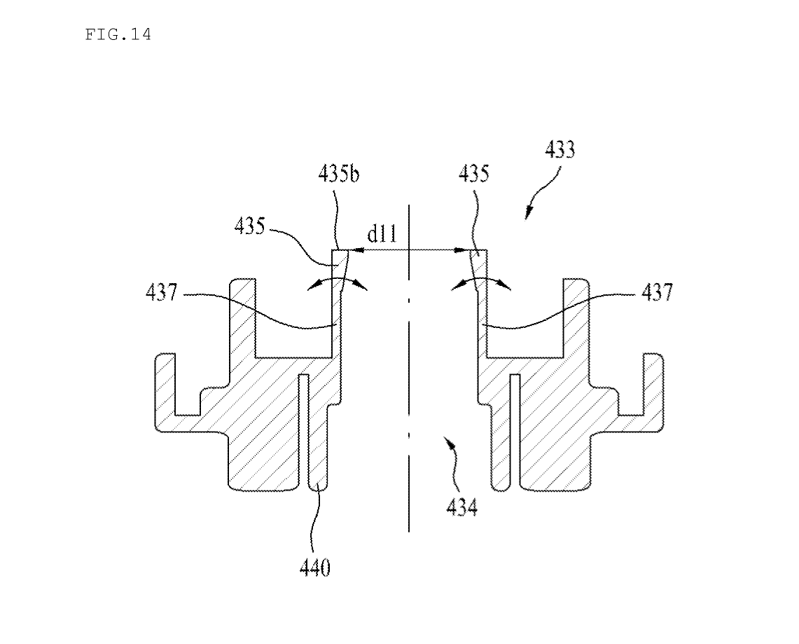

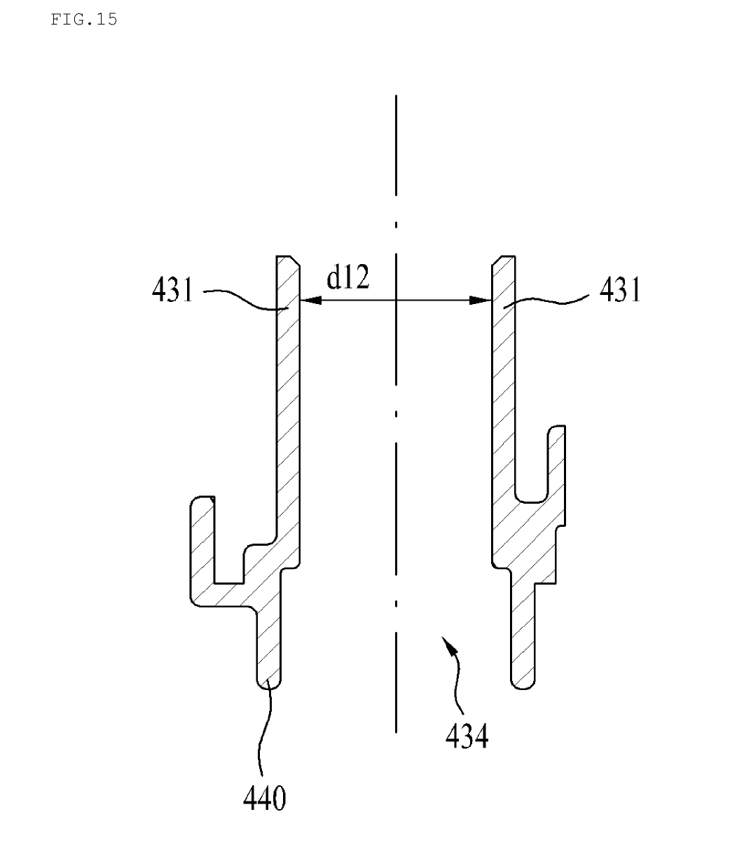

FIG. 9 is a side view of a rear holder 400 according to the present invention. FIG. 10 is a rear perspective view of the rear holder 400 according to the present invention. FIG. 11 is a rear view of the rear holder 400 according to the present invention. FIG. 12 is a front perspective view of the rear holder 400 according to the present invention. FIG. 13 is a front view of the rear holder 400 according to the present invention. FIG. 14 is a longitudinal sectional view of the rear holder 400 along A-A of FIG. 13. FIG. 15 is a longitudinal sectional view of the rear holder 400 along B-B of FIG. 13.

As shown in FIGS. 9 to 15, the rear holder 400 is detachably coupled to the terminal housing 300 via the coupling projection 321 of the terminal housing 300, to determine the coupling or accommodating positions of the terminals 200 in the terminal housing 300 and to assure the coupling or accommodating positions of the terminals 200 in the terminal housing 300 simultaneously. In addition, the rear holder 400 may prevent the rearward moving of the terminals 200 when the terminal housing 300 and the rear holder 400 are coupled to each other.

Referring to FIGS. 9 to 15, the rear holder 400 includes a rear cover 410 configured to cover a rear end of the terminal housing 300 and to define an outermost circumference of the rear holder, a plurality of rear accommodating members 440 extended from a rear surface of the rear cover 410 backwards, having a cylindrical shape, and a plurality of front accommodating members 430 extended from a front surface of the rear cover 410 forwards, in communication with the rear accommodating members 440, to determine the coupling positions of the terminals 200. The front accommodating members and the rear accommodating members 440 are in communication with each other, to form a through hole. The terminals 200 may pass the rear holder 400 via the through hole.

The rear cover 410 includes a base 414 configured to partition the other area thereof into the rear accommodating members and the front accommodating members 430, except an area corresponding to the through hole, a circumference part 412 formed in a cylindrical shape to surround a predetermined area of the rear cylindrical part 320 of the terminal housing when the terminal housing 300 and the rear holder 400 are coupled to each other, with lying in a perpendicular direction of the base 414, and a leg 411 spreading from an edge of the base 414 in a backward perpendicular direction with respect to the base 414, with spreading higher than the circumference part 412 backwards.

At this time, an inner diameter (d13) of the rear cover 410 (in other words, the circumference part 412 and the leg 411) is identical to an outer diameter (d9) of the rear cylindrical part 320 of the terminal housing 300. In other words, a free end of the rear cylindrical part 320 provided in the terminal housing 300 is partially positioned in the circumference part 412 and the leg 411 provided in the rear cover 410.

It is preferred that a ring type sealing member (not shown) is further provided in the rear cover 410, with an outer diameter identical to an inner diameter (d13) of the rear cover 410. The ring type sealing member is inserted in the circumference part 412 of the rear cover 410 to be fixed by the free end of the rear cylindrical part 320 provided in the terminal housing 300 when the terminal housing 300 and the rear holder 400 are coupled to each other. Accordingly, the inside of the assembly of the terminal housing 300 and the rear holder 400 may be made waterproof more definitely.

The leg 411 surrounds a predetermined area of an outer circumferential surface of the rear cylindrical part 320 provided in the terminal housing 300, when the terminal housing 300 and the rear holder 400 are coupled to each other. The leg 411 includes a coupling recess 413 configured to fixedly accommodate the coupling projection 321 provided in the rear cylindrical part 320. The leg and the circumference part 412 are positioned adjacent to each other. Two legs 411 are provided in opposite sides in a circumferential direction. A cut-away part 415 is formed between the leg 411 and the circumference part 412 to allow the leg 411 to have an elastically transformable structure. In other words, cut-away parts 415 are formed in both sides of the leg 411. Two legs 411 are provided in the present invention as one of examples and the present invention is not limited thereto.

When the terminal housing and the rear holder 400 are coupled to each other, the leg 411 is temporarily and elastically expanded outwards while sliding along the inclined surface of the coupling projection 321. After that, when the coupling projection 321 is completely accommodated by the coupling recess 413 of the leg 411, the leg 411 elastically shrinks to fix the coupling projection 321 to the coupling recess 413. In contrast, when the terminal housing 300 and the rear holder 400 are dissembled, the leg 411 is elastically expanded outwards via the cut-away part 415, using a tool such as a driver, and the coupling projection 321 is detached from the coupling recess 413.

The plurality of the rear accommodating members 440 are spreading from a rear surface of the base 414 provided in the rear cover 410 backwards, in communication with the front accommodating members 430 to form a through hole where the terminals 200 pass. When the assembly of the terminal housing 300 and the rear holder 400 is mounted in the case 100, predetermined areas of the rear accommodating members 440 may be closed airtight by the ring type rib 150 formed in the case 100. In other words, the ring type rib 150 of the case 100 is projected toward the inside of the case 100 to make an inner diameter (d5) of the ring type rib 150 smaller than a diameter (d10) of a common circumscribed circle surrounding the rear accommodating members 440, such that the ring type rib 150 may close the predetermined area of each rear accommodating member 440 airtight.

It is preferred that a sealing member 500 is arranged in the rear accommodating member 440 to make the inside of the assembly of the terminal housing 300 and the rear holder 400 waterproof.

As the ring type rib 150 of the case 100 is configured to close the predetermined area of the rear accommodating member 440 airtight, the rear accommodating member 440 is prevented from moving backwardly within the case 100 and the coupling or accommodating position of the rear accommodating member 440 may be definitely assured. Simultaneously, the sealing member 500 arranged in the rear accommodating member 440 may be fixed in the rear accommodating member 440, to make the inside of the assembly of the terminal housing 300 and the rear holder 400 waterproof.

The front accommodating member 430 includes a plurality of position assurance members and a plurality of clip members. For explanation convenience, two position assurance members and two clip members are provided as one of examples and the present invention is not limited thereto.

Specifically, the front accommodating member includes two position assurance members 431 positioned in opposite in an arc-shaped column to assure the coupling or accommodating positions of the terminals, two clip members 433 positioned in opposite between the position assurance members 431 to support the ring type hooking protrusion 220 after the terminals 200 pass there through, and a cut-away part 439 formed between the position assurance members 431 and the clip members 433. At this time, the two position assurance members 431 and the two clip members 439 are formed approximately in a cylindrical shape. In the present invention, only two clip members 433 and two position assurance members 431 are disclosed as one of examples and the present invention is not limited thereto.

Referring to FIGS. 13 and 15, the clip member 433 includes an elastic transformable part 435 positioned in a free end of the clip member 433 to temporarily and elastically expand when the terminals 200 pass there through and to elastically shrink after the terminals 200 completely pass the clip member 433, and a support part 437 extended from a front surface of the rear cover 410 (or the front support part 420) forwards to support the elastic transformable part 435.

The elastic transformable part 435 includes an inclined surface 435a where the ring type hooking protrusion 220 of the terminal slides, when the terminals 200 pass the clip members 433, and a hooking surface 435b supporting a rear surface of the ring type hooking protrusion 220 of the terminal, when the terminals 200 completely pass the clip members 433.

The hooking surface of the elastic transformable part 435 provided in the clip member 433 (in other words, a free end of the clip member 433) is positioned to face a free end of the rear guide member 323 provided in the terminal housing 300 when the terminal housing 300 and the rear holder 400 are coupled to each other. The hooking surface of the elastic transformable part 435 supports the ring type hooking protrusion 220 of the terminal 200, together with the free end of the rear guide member 323, to prevent the terminals 200 from moving forwards or backward within the assembly of the terminal housing 300 and the rear holder 400. Accordingly, the coupling or accommodating positions of the terminals 200 may be assured within the assembly of the terminal housing 300 and the rear holder 400.

It is preferred that the height of the clip member 433 is identical to the distance where the free end of the rear guide member provided in the terminal housing 300 is spaced apart from the free end of the clip member 433 as far as the thickness of the ring type hooking protrusion 220 of the terminal 200.

The height of the clip member 433 is smaller than the height of the position assurance member 431 adjacent to the clip member and an inner diameter (d11) of the free ends of the two clip members 433 is smaller than an outer diameter (d2) of the ring type hooking protrusions 220 provided in the terminals 200.

Accordingly, when the terminal housing 300 and the rear holder 400 are coupled to each other, the rear guide member 323 of the terminal housing 300 is partially inserted in the position assurance member 431 of the clip member 433 to accommodate the terminal 200. The other area of the rear guide member 323 of the terminal housing 300 stably supports the ring type hooking protrusion 220 of the terminal, together with the clip member 433.

The position assurance member 431 may be an arc-shaped column and the rear guide member of the terminal housing is inserted in the position assurance member. An inner diameter (d12) formed by the two position assurance members 431 is identical to an outer diameter (d2) of the ring type hooking protrusion 220 provided in the terminal 200 and larger than an inner diameter (d11) formed by the two clip members 433. The height (h1) of the position assurance member 431 is larger than the height (h2) of the clip member 433 and an inner diameter (d12) of the position assurance member 431 is identical to an outer diameter (d7) of the rear guide member 323 provided in the terminal housing 300.

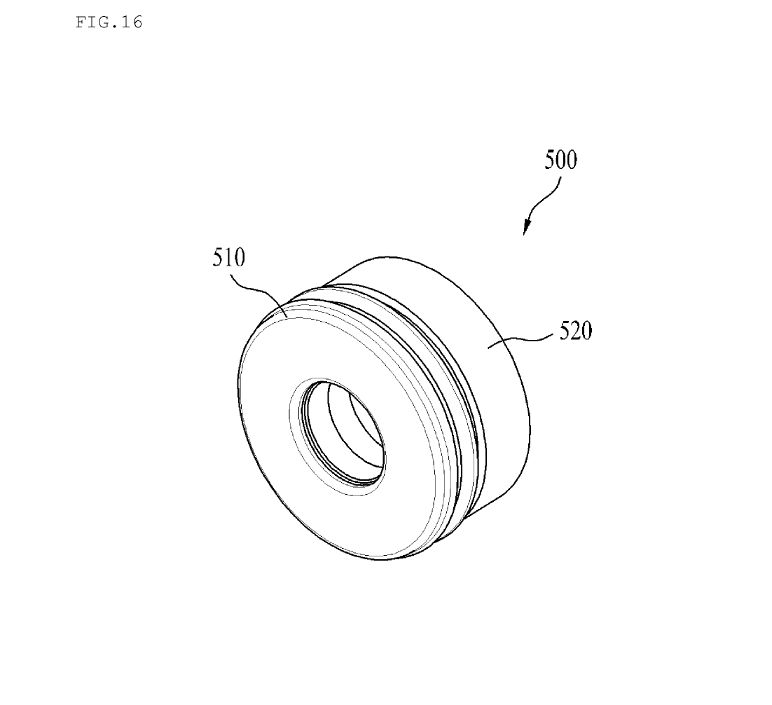

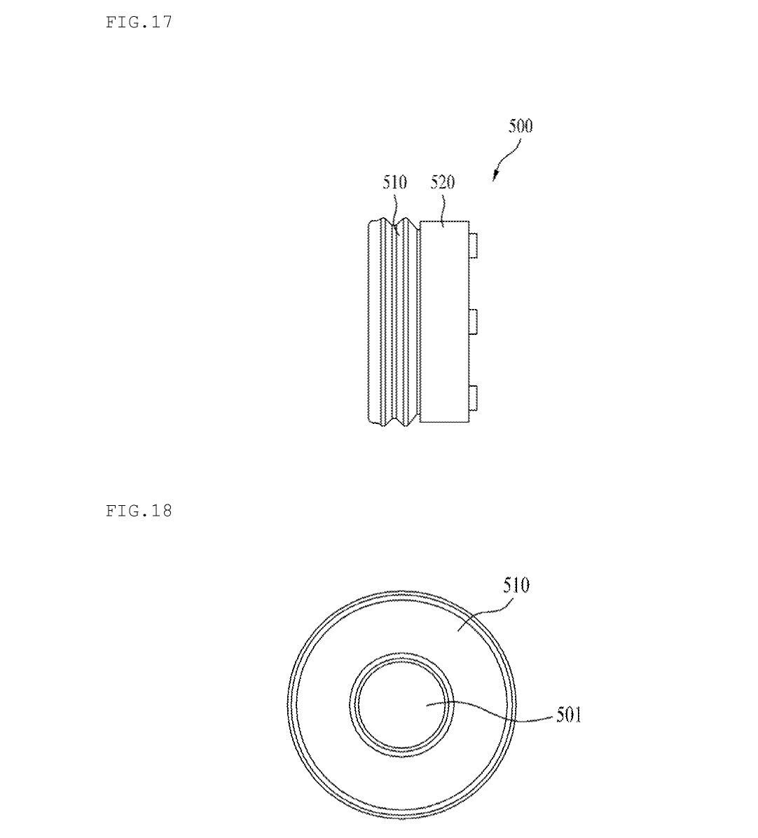

FIG. 16 is a front perspective view of a sealing member 500 according to the present invention. FIG. 17 is a side view of the sealing member 500 according to the present invention.

As shown in FIG. 2, a sealing member 500 is provided in the rear accommodating member 440 of the rear holder 400.

As shown in FIGS. 16 to 18, the sealing member 500 includes a through hole where the cables pass. Furthermore, the sealing member 500 includes an elastic part 510 and a rigid part 520 coupled to a lower portion (or a lower surface) of the elastic part 510.

The elastic part 510 is arranged in the rear accommodating member 440 of the rear holder 400 forwards and an outer diameter of the elastic part 510 is larger than an inner diameter of the rear accommodating member 440 provided in the rear holder 400. Accordingly, the elastic part 510 may be fixedly and forcedly fitted in the rear accommodating member 440, to prevent foreign substances such as water from penetrating via the rear accommodating member 440.

It is preferred that the elastic part 510 has a bellows shape to have an elastic transformable structure. It is more preferred that the elastic part 510 is formed of rubber. Accordingly, even when the cables passing through the elastic part 510 positioned in the rear accommodating member 440 of the rear holder 400 move in a predetermined range, the elastic transformation of the elastic part 510 generates no gap between the rear accommodating member 440 and the elastic part 510 and the rear accommodating member 440 can be made waterproof constantly.

The rigid part 520 is arranged backwards within the rear accommodating member 440 of the rear holder 400. It is preferred that the rigid part 520 is formed of plastic. The rigid part 520 may prevent the elastic part 510 from being torn apart by too much moving of the cables passing through the elastic part 510 positioned in the rear accommodating member 440 of the rear holder 400, only to enhance durability and mechanical rigidity of the sealing member 500.

It is preferred that the elastic part 510 and the rigid part 520 provided in the sealing member 500 are fabricated by double-injection molding.

It is also preferred that the sealing member further include a plurality of rigid seams. The plurality of the rigid seams 530 may be formed of a rigid material, for example, a plastic material and they are fixed to the rigid part, with being positioned passing through the elastic part 510 and the rigid part 520. The rigid seams 530 may pass through the rigid part and partially or completely pass through the elastic part. Even when the cables passing through the elastic part 510 arranged in the rear accommodating member 440 of the rear holder 400 presses the elastic part 510 too much, the sealing member 500 includes the rigid seams and the elastic part is prevented from being pushed too much in a predetermined direction. The pressure applied to the elastic part may be dispersed to the rigid part uniformly and the damage to the elastic part can be prevented definitely.

The assembling process of the connector 1000 of the electric vehicle charger according to the present invention will be described as follows.

First of all, in the assembling process of the connector 1000 of the electric vehicle charger according to the present invention, the ends of the cables pass through the through hole of the sealing member 500 and the ends of the cables are pressed and electrically connected to the connected parts 230 of the terminals 200, respectively, after that. The terminals and the cables are pressed and connected with each other before they are inserted in the assembly of the terminal housing and the rear holder, only to make the pressing connection process between the terminals and the cables performed easily.

The rear holder 400 is sliding to the rear cylindrical part 320 of the terminal housing 300 to position the coupling projection 321 of the terminal housing 300 in the coupling recess 413 of the rear holder 400, only to fix the rear holder 400 to the terminal housing 300.

After that, the plurality of the terminals 200 are separately inserted in the assembly of the terminal housing 300 and the rear holder 400 via the rear accommodating members 440 of the rear holder 400. The sealing member positioned behind the connected part 230 of the terminal 200 is inserted in the rear accommodating member 440 of the rear holder 400. At this time, the connection parts 210 of the terminals 200 are accommodated by the front guide members 311 of the terminal housing 300 to assure the coupling positions of the terminals 200. The ring type hooking protrusions 220 of the terminals 200 are fixedly supported by the hooking surfaces of the clip members 433 of the rear holder 300 and the free end of the rear guide member 323 of the terminal housing 300. Simultaneously, the ring type hooking protrusion 220 is positioned in the position assurance members 431 of the rear holder 400, to assure the coupling positions of the terminals 200 within the terminal housing 300 or the case 100 definitely.

Hence, the left and right portions of the case 100 are connected with each other and the assembling process finishes. At this time, the assembly of the terminal housing 300 and the rear holder 400 may be mounted in the case 100 to position the first and second ring type hooking protrusions 330 and 340 of the terminal housing 300 between the first and second ring type projections 130 and 140 of the case 100 and to make the predetermined area of the rear accommodating member 440 of the rear holder closed airtight by the ring type rib 150 of the case 100.

The disassembling process of the connector 1000 of the electric vehicle charger is performed in the reverse of the assembling process.

As mentioned above, the structure of the connector can be simplified and the number of the parts composing the connector can be reduced according to the present invention. Accordingly, the present invention may enhance the productivity of the connector and lower the production cost simultaneously.

Moreover, the connector according to the present invention can be easily assembled and dissembled. The components provided in the connector according to the present invention can be easily assembled and dissembled. Specifically, after pressed and connected to the cables, the terminals can be separately inserted in the rear holder and the terminal housing. Accordingly, the pressing and connecting process between the cables and terminals can be performed easily and the assembling or dissembling process of the terminal housing and the rear holder can be performed easily. The assembling and dissembling process between the assembly of the terminal housing and the rear holder and the terminals may be performed easily. Accordingly, when each of the components is damaged (for example, a pressure state error generated between the connected parts of the terminals and the cables) or the components need replacing, the assembling and dissembling between the components is performed easily and maintenance of the connector can be performed efficiently.

Moreover, the accommodating or coupling positions of the terminals can be assured within the connector definitely. Specifically, the ring type hooking protrusion is fixed between the terminal housing and the rear holder, only to assure the accommodating or coupling positions of the terminals.

Also, the coupling positions of the terminal housing and the rear holder mounted in the connector according to the present invention definitely. Especially, the forward and backward moving of the terminal housing and the rear holder within the case can be prevented.

According to the present invention, the sealing member is positioned in the front or rear portion of the rear holder. The separation of the sealing member can be prevented and the inside of the connector can be made waterproof accordingly.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A connector of an electric vehicle charger comprising:
a case;
a terminal housing mounted in the case;
a rear holder detachably mounted in the terminal housing; and
a plurality of terminals inserted in the terminal housing via the rear holder, with hooking protrusions formed in outer circumferential surfaces thereof, respectively,
wherein a hooking protrusion of each terminal is positioned between the terminal housing and the rear holder, and
a first terminal fixing part is provided in the terminal housing to prevent the hooking protrusion of each terminal from moving forwards, and
a second terminal fixing part is provided in the rear holder to prevent the hooking protrusion of each terminal from moving backwards.

2. The connector of the electric vehicle charger according to claim 1, wherein the first terminal fixing part comprises a plurality of rear guide members extended from the terminal housing backwards, and
the second terminal fixing part comprises a plurality of clip members extended from the rear holder forwards to face the plurality of the rear guide members, when the terminal housing and the rear holder are coupled to each other.

3. The connector of the electric vehicle charger according to claim 2, wherein the clip member comprises an elastic transformable part comprising:
an inclined surface configured to guide the sliding movement of the hooking protrusion when the terminals pass the clip members; and
a hooking surface to support a rear surface of the hooking protrusion.

4. The connector of the electric vehicle charger according to claim 2, wherein the rear guide member is extended from the terminal housing to be spaced apart a predetermined distance from the clip member as far as the thickness of the hooking protrusion, when the terminal housing and the rear holder are coupled to each other.

5. The connector of the electric vehicle charger according to claim 2, wherein an outer diameter of the rear guide member is identical to the height of the hooking protrusion.

6. The connector of the electric vehicle charger according to claim 2, wherein the rear holder comprises a plurality of position assurance members provided between the clip members, to insert the rear guide members there through, and
an inner diameter of the position assurance member is identical to the height of the hooking protrusion.

7. The connector of the electric vehicle charger according to claim 2, wherein the rear holder comprises a plurality of rear accommodating members extended from the rear holder backwards, in communication with the clip members, and
a sealing member is provided in the rear accommodating member, with a through hole where the cables pass.

8. The connector of the electric vehicle charger according to claim 7, wherein the sealing member comprises,
an elastic part positioned in the rear accommodating member forwards; and a rigid part coupled to a rear surface of the elastic part.

9. The connector of the electric vehicle charger according to claim 8, wherein the elastic part has a bellow shape and an outer diameter of the elastic part is larger than an inner diameter of the rear accommodating member.

10. The connector of the electric vehicle charger according to claim 8, wherein the elastic part is formed of rubber and the rigid part is formed of plastic.

11. The connector of the electric vehicle charger according to claim 8, wherein the sealing member comprises a plurality of rigid seams formed of a rigid material to pass through the elastic part and the rigid part.

12. The connector of the electric vehicle charger according to claim 1, wherein the terminal housing and the rear holder are detachably mounted in the case.

13. The connector of the electric vehicle charger according to claim 7, wherein a ring type rib is projected inwards in the case to close airtight a predetermined area of a rear accommodating member provided in the rear holder.

14. The connector of the electric vehicle charger according to claim 13, wherein an inner diameter of the ring type rib is smaller than a diameter of a common circumscribed circle surrounding the plurality of the rear accommodating members.

15. The connector of the electric vehicle charger according to claim 12, wherein at least one ring type hooking protrusion is provided in an outer circumferential surface of the terminal housing, and
at least one ring type projection is projected from the case inwards to support the ring type hooking protrusion of the terminal housing.

16. The connector of the electric vehicle charger according to claim 1, wherein the plurality of the terminals comprises at least one communication terminal and at least one electric terminal.

17. A connector of an electric vehicle charger comprising:
a case;
a terminal housing mounted in the case;
a rear holder detachably mounted in the terminal housing;
a plurality of terminals comprising a hooking protrusion formed in an outer circumferential surface thereof, with cables connected thereto; and
a sealing member coupled to the rear holder to pass the cables there through,
wherein a hooking protrusion of each terminal is positioned between the terminal housing and the rear holder when the terminals are inserted in the terminal housing via the rear holder, and
a rear guide member is provided in the terminal housing to contact with a front surface of the hooking protrusion of each terminal, and
a plurality of clip members provided in the rear holder to contact with a rear surface of the hooking protrusion of each terminal.

18. The connector of the electric vehicle charger according to claim 17, wherein the rear guide member prevents forward moving of the terminals and the clip member prevents backward moving of the terminals.

19. The connector of the electric vehicle charger according to claim 17, wherein the clip member comprises an elastic transformable part comprising:
an inclined surface configured to guide the sliding movement of the hooking protrusion when the terminals pass the clip members; and
a hooking surface to support a rear surface of the hooking protrusion.

20. The connector of the electric vehicle charger according to claim 17, wherein the rear guide member is extended from the terminal housing to be spaced apart a predetermined distance from the clip member as far as the thickness of the hooking protrusion, when the terminal housing and the rear holder are coupled to each other.
